(19) United States
(12) Patent Application Publication
(10) Pub. No.: US 2014/0316797 A1
(43) Pub. Date: Oct. 23, 2014

(54) Methods and system for evaluating medication regimen using risk assessment and reconciliation

(71) Applicants: Anne Marie Biernacki, Cambridge, MA (US); Patricia S. Meisner, Northport, ME (US); Patricia J. Neafsey, Stafford Springs,, CT (US)

(72) Inventors: Anne Marie Biernacki, Cambridge, MA (US); Patricia S. Meisner, Northport, ME (US); Patricia J. Neafsey, Stafford Springs,, CT (US)

(21) Appl. No.: 14/256,914

(22) Filed: Apr. 18, 2014

Related U.S. Application Data
(60) Provisional application No. 61/813,995, filed on Apr. 19, 2013.

(51) Int. Cl. G06F 19/00

(52) U.S. Cl. CPC G06F 19/3456; G06F 19/3431
USPC 705/2

(57) ABSTRACT

Computer-based and network-based methods and system that provide for evaluating medication regimen using medication-related risk assessment in an automated medication reconciliation process can comprise, without limitation, collecting comprehensive information with respect to a patient that can fill in gaps typical of claims, EHR, or HIE-based data sets, based on curated clinician review and annotation or tagging of data. Various embodiments introduce flexible use of a variety of accurate and efficient methods for capturing and characterizing medications in point-of-care settings, including structured interviews, bar code scanning, and image recognition. Embodiments of the invention can further provide for harmonizing and reconciling data from disparate sources, calculating risk based on a more comprehensive assessment and annotation of the data sets and comparing risk to create a risk offset or differential, with a subsequent tailoring of interventions based on the risk offset or differential.

### REFERENCE TO OTHER APPLICATIONS

Reference is made to and priority claimed from U.S. Provisional Patent Application No. 61/813,995, filed 19 Apr. 2013 by Biernacki et al., which application is hereby incorporated in its entirety herein.

### U.S. GOVERNMENT RESEARCH

N/A

### FIELD

Various embodiments relate generally to health care and relate more particularly, without limitation, to evaluating medication regimen and associated risks and to reconciling medication-related information.

### BACKGROUND

In order to treat a disease or a medical condition, medical professionals often prescribe various medical treatments to patients. A medical treatment can include prescribing a medication that must be taken in prescribed doses by a patient at certain intervals over the course of a treatment period. Patients also commonly “self-prescribe” over-the-counter, neutraceutical, or herbal/alternative agents commonly available in retail settings.

Coincident with the management of medical conditions and administration of medications is the medication reconciliation and review process. Healthcare providers are required to accurately and completely reconcile and review medications (and treatments) across the continuum of care during the care of a patient. Medication reconciliation may occur at various instances during the care continuum, including (1) in a variety of outpatient or ambulatory settings (clinic, home, or community), (2) as a result of a change or transition of care, and (3) on admission to, discharge from, or in the course of an inpatient visit. Medication reconciliation will typically begin by compiling a patient's current active medication list (this can include prescribed medications issued in either an ambulatory or inpatient setting, and any medications or agents that have been self-prescribed or received from other sources) by either receiving a list as compiled by a patient or caregiver, and/or via clinician review. Beginning with a list of previously prescribed medications can be used to facilitate workflow in updating a current medication list as the patient is currently taking medications. This list is compared or reconciled to any available current active medication information that can be obtained—this would consist of data available from an electronic Health Record (EHR), e-prescribing system, Health Information Exchange (HIE), claim or fill records, or other institutional sources. However, this information may be incomplete or limited in scope, and require review and annotation in compiling a complete view of medication context. Medications presented during an in-person review may not be in original or labeled packaging, adding complexity to medication assessment. The comparison and reconciliation process enables the potential identification of gaps or risks associated with actual patient self medication choices and behaviors, including dosage, timing, self-prescribing, and adherence. Additional context for medication use—for example, self-prescribing to address symptoms, or unreported or diagnosed conditions, or biometric or lab measures that indicate medication outcomes—also inform risk management and optimization of medication regimens. Drug prescriptions issued blind to a patient's self-administration of over-the-counter compounds can lead to various adverse outcomes which can place added burden on the health care system. Poor adherence to a prescription can decrease the overall effectiveness of the prescribed treatment and thus adversely affect the health of the patient. Poor adherence can lead to more serious medical conditions that are more costly to treat than the original condition and can increase the overall recovery time. A medical professional may not be aware of a patient's poor adherence and may increase the patient's prescribed treatment owing to the patient's poor progress. This can lead to over-treatment and to greater risks to the patient's safety. In a clinical trial setting, poor adherence to medical prescriptions by a clinical trial participant may adversely affect the results of the clinical trial. All of these items should be identified to optimize the results of medication therapies, but historically these have been difficult to capture and reduce to actionable data.

Patel et al. disclose system and techniques for managing patient medication data which include, in one implementation, receiving medication data for a patient from multiple sources and reconciling the medication data from multiple sources to generate a reconciled list of medications for the patient, for the purpose of predicting a likely effect of provided prescriptions on adherence (Patent Application No. 20120179481, filed Jan. 10, 2011 and published 12 Jul. 2012, incorporated herein by reference in its entirety).

Lesselroth, et al. disclose a system of automated patient history intake including a retrieval system for retrieving pharmaceutical information specific to a patient, a display system for displaying the pharmaceutical information, and a reconciliation system for reconciling the pharmaceutical information using visual data. (Patent Application 20110166884, published 7 Jul. 2011, incorporated herein by reference in its entirety).

McGuigan et al. disclose a healthcare risk index generated using a patient or individual's pharmacy claim, which index may be used to explain and predict variation in pharmacy-related costs and variation in total healthcare costs or utilization. In particular, the index is generated by first examining the individual's pharmacy claims to identify any chronic conditions possessed by the individual. Similarly, the individual's pharmacy claims are examined to identify any compliance medications prescribed to the individual. (U.S. Pat. No. 7,725,327, issued May 25, 2010, incorporated herein by reference in its entirety).

G. Dunlop has disclosed computer-based systems and methods for reconciling medications at long-term care facilities, including a patient care management system integrated with a communications network for accessing third-party computer systems. The patient care management system comprises an EMR system, a medication reconciliation system, a data entry device, and one or more databases adapted to receive and store multiple patient and medical data. A computer-enabled method comprises first providing a system adapted to reconcile medications, including collecting data for a medication from the data entry device into a new medication panel repository and creating a medication line item from the information in the new medication panel repository. (U.S. Patent Application Pub. No. 20110029327, published Feb. 3, 2011 and filed Jul. 29, 2009; incorporated by reference herein in its entirety).

Villasenor et al. (Siemens Corporation, Iselin, N.J.), disclose an integrated clinical and medication reconciliation system that includes a clinical information system incorporating a patient record management system and treatment order processing system. A medication reconciliation system incorporates a user interface providing a display image including a first image area identifying medications a patient is receiving following admission to a healthcare provider facility and a second image area indicating medications the patient received prior to admission to a healthcare provider facility and a third image area indicating a consolidated list of medications and enabling a user to individually select medications to be added from the first and second image areas to the third image area. (U.S. Patent Application Pub no. 20070143141, filed Dec. 7, 2006; incorporated by reference herein in its entirety).

Martin et al. disclose methods and systems for healthcare treatment, assessment and planning, including predicting the likelihood of an entity entering a degraded future state by computing a risk value (by evaluation of a function that considers a variety of historic, environmental, and systemic behaviors and conditions) and basing healthcare decisions on a multi-factorial computation of risk. In addition to considering a risk value, a treatment plan developed in accordance with the healthcare system considers symptoms and objectives of the treatment from the perspective of both the patient and the provider. The outcomes associated with treatment and risk assessment are fed back into the healthcare system to increase its accuracy and subsequent effectiveness in computing risk values over time. (U.S. Pat. No. 6,484,144, issued Nov. 19, 2002; incorporated by reference herein in its entirety).

Harpale discloses a method and apparatus to record and track patient's estimation of arbitrary factor types, to analyze response errors utilizing discrete measurements, to isolate errors in various factor types and their response correlations, to enable a patient in refining the factor mix to reduce estimated outcome variations, and to improve patient estimation with corrections using a continuous feedback system. (U.S. Pat. No. 8,185,412, issued May 22, 2012, filed Jan. 2, 2009; incorporated by reference herein in its entirety).

Knowlton et al. disclose a system and method of facilitating a patient's care transitions both into and upon subsequent discharge from an in-patient medical facility utilizing three points of health care provider intervention. The system and method utilizes a cloud-based medication management system applying rules to determine whether the patient's medications, clinical lab results, genomic information, or other relevant considerations would, in combination, amount to an adverse health outcome. If an adverse health outcome is predicted based on an application of the pre-programmed rules, health care intervention is sought. (United States Patent Application Pub. No. 20120116810, Pub. May 10, 2012, filed Nov. 8, 2011; incorporated by reference herein in its entirety).

Patel et al. disclose systems and techniques for determining an intervention for a patient based in part on a likelihood of the patient to adhere to a prescription, wherein a patient profile that is based on multiple patient attributes can be obtained in a patient population; an adherence score for the patient profile is obtained for predicting patient adherence based on one or more of the multiple patient attributes wherein the adherence score indicates a likelihood of adherence of the patient to a prescribed treatment; and the adherence score obtained for the patient profile is modified into a modified score for intervention based on a set of weights for weighting the patient attributes. (U.S. Patent Application No. 20110106556, published May 5, 2011, filed Jan. 10, 2011; incorporated herein by reference in its entirety).

Tanimoto, et al. (U.S. Pat. No. 8,396,722, Mar. 12, 2013, herein incorporated by reference in its entirety) disclose a medicine examination support system that can involve use of RFID tags and/or bar codes for inpatient inspection and identification of containers used for dispensing medication. U.S. Pat. No. 8,386,274 to Pinsonneault (Feb. 26, 2013, herein incorporated by reference in its entirety) discloses use of bar codes in association with a prescription safety network and verifying patient enrollment in a program from available data sources. U.S. Pat. No. 8,392,219 to Pinsonneault, et al. (Mar. 5, 2013, herein incorporated by reference in its entirety) discloses bar coding for use in association with verifying patient enrollment in a program from available data sources. U.S. Pat. No. 8,392,216 to Crockett (Mar. 5, 2013, herein incorporated by reference in its entirety) discloses bar coding tied to electronic medical records, described in the context of room identification for inpatient use in making correct association between patients and records.

Bertha, et al. (U.S. Pat. No. 8,392,209; Mar. 5, 2013, herein incorporated by reference in its entirety) disclose use of bar coded data to associate drug order and claim via pharmacy systems. U.S. Pat. No. 8,380,536 to Howard, et al. (Feb. 19, 2013, herein incorporated by reference in its entirety) describes the use of barcodes in drug delivery in service environments, including pharmacy settings. Newcomb, et al. (U.S. Pat. No. 8,284,305; Oct. 9, 2012, herein incorporated by reference in its entirety) discloses image scanning for association of correct medications in pharmacy and dispensing settings.

A “Patient Education Program—Next Generation” (PEP-NG) program and supporting research was developed at the University of Connecticut School of Nursing, under the guidance of Dr. Patricia Neafsey and colleagues, and includes the following components:
“PEP-NG” structured interview format for capturing patient self-reported medication and health status,
“PEP-NG” Risk Rules for assessing risks from information gleaned in the structured interview,
“PEP-NG” Tailored content delivery and mechanism keyed to the risks and specific reported information from the interview tool,
“PEP-NG” data and content summaries provided to patient and provider, and
Research results and outcomes, and use of data from studies.

In assessing medication risk for high risk patients, many organizations such as payers and provider groups that bear their own risk have based risk review on analyses of well-established records, such as claims data or clinical health records. However, these data sources represent a snapshot of the patient medication status that may be incomplete, imprecise and/or ambiguous for a variety of reasons. Missing information is likely to include out-of-network provider prescriptions, “as-dispensed” information from retail pharmacies, self-pay prescriptions, over the counter medications and dietary supplements. In addition, medication risk is assessed out of context with patent or member's actual self medication patterns and habits, and therefore likely omits key information that could have a significant impact on assessing regimen efficacy or other critical topics to payer, such as fraud and misuse. Missing information at care transitions also increases risk. Direct patient input and feedback is not consistently solicited via either clinician or other professional interview, or directly from the patient or a caregiver on their behalf.

In addition, data useful for assessing medication regimen risk for a particular patient or member can come from multiple sources. Independent analysis and reconciliation of information from these multiple sources can provide a basis for assessing the integrity and utility of data from multiple external sources. In order to improve patient outcomes, improved systems and methods are needed that can allow health-care managers and caregivers to determine a patient's health risk more comprehensively, accurately, and efficiently. Significant additional improvement to medication risk based on a comprehensive assessment and comparisons of multiple information sources relevant to the specific patient and enhanced by context and decision support can then be used to reduce a large amount of data to actionable information Then, this improved information on risk needs to be associated with certain more-precisely targeted interventions available to the caregiver and patient, in order to thereafter reduce the patient's risk of negative health outcomes. The information system needs to support participation, input, and data annotation from a broad variety of data contributors and stakeholders across the patient care continuum, with a variety of clinical users with different skill and licensure levels participating in data capture and review at different points of care. It also needs to account for patient engagement and participation in the medication reconciliation and risk review process, including the option of self reporting and review of results.

### SUMMARY

The invention generally provides for collecting comprehensive information with respect to a patient, which collection can be from the patient via self-reporting, or via caregiver-assisted reporting, or via healthcare provider-enabled data capture and which information fills in the gaps typical of claims, EHR, or HIE-based data sets based on a final curated clinician review and annotation or tagging of data. Various embodiments introduce flexible use of a variety of accurate and efficient methods for capturing and characterizing medications in point of care settings with the goal of streamlining workflow, including structured interviews, bar code scanning, and image recognition. These methods can be used individually or in aggregate as circumstances dictate. A variety of devices that can be connected via HyperText Transfer Protocol Secure (HTTPs) can be used to facilitate delivery in a variety of point-of-care settings—requiring only internet browser and online access. Various preferred embodiments can be deployed on a PC or laptop computer, tablet or mobile device, such as, for example, a smartphone. One or more embodiments of the invention provide for calculating risk based on a comprehensive assessment and annotation of the data sets. Comparing risk from this additional context to previously assessed risk, in certain preferred embodiments, can provide a basis for more precise understanding of risk factor contributors and for subsequent tailoring of interventions based on the risk offset. The risk offset itself (as expressed by the difference in risk score between data sources) can be used as a performance measure. When the risk offset is between prescription order data via EHR or HIE sourced orders and subsequent claim or pharmacy fill data, it can be applied assess primacy adherence. Alternatively the risk offset can be used as a data quality or completeness performance measure, in comparing EHR and HIE data.

The invention further provides for closing the loop between data that represents institutional or retrospective views and analyses of a patient or member's information, and data that represents real-time and real-world medication landscape and practices. It also provides for direct association of recommended interventions and responses to specific risk “triggers” (“triggers” being factors that are likely causes of risk) and data elements. Various embodiments also provide for mechanisms (or modules) for establishing data validation for other potentially incremental sources that may illuminate risks. Data captured can include, without limitation, medication lists, symptoms, conditions or diagnoses, allergies, lifestyle and health status information (such as, for example, smoking, alcohol use, exercise, sleep patterns) and social and mechanical support for appropriate self medication or management.

At least one embodiment of the invention provides for a method implemented in a data processing system for assessing medication risk and improving treatment regimen for a patient, the method comprising the following steps: (1) automatically capturing or ingesting data from external information sources via machine interfaces and via human data entry, (2) aggregating and comparing via comparison of coded, numeric, or standard values the clinical or claims data that indicate a comprehensive, current state of a patient's treatment or therapeutic regimen via one or more external information sources, (3) and harmonizing the data to present a reconciled view of medication and other critical information (such as, for example, without limitation, indication or diagnosis, or allergy). In at least one preferred embodiment the external information sources comprise at least one of claims, clinical systems (e.g., Electronic Health Records (EHRs) and/or Health Information Exchanges (HIEs)), clinician and professional direct data-capture, said data-capture also being effected through one or more of a variety of mechanisms (e.g., without limitation, bar-code scanning in order to extract NDC code from commercial UPC codes or other barcoded data sources, image recognition, and/or structured interviewing) and patient or caregiver direct information reporting.

One or more embodiments can provide for, in addition to the above steps, the further steps of: (4) computing one or more first risk values for the patient associated with each concurrent distinct source of the automatically received data, each one of the first risk values being based on a subset of the automatically received data and indicating a likelihood of the patient developing sub-optimal outcomes per the existing treatment plan; (5) computing one or more second risk values for the patient associated with an additional risk calculation based upon combining annotation or augmentation of (i) the automatically received data and (ii) information captured directly from the patient via a data capture interface (comprising in part a patient-based assessment), each one of the second risk values being based at least in part on data unique to the annotation or augmentation process and indicating a likelihood of the patient developing sub-optimal outcomes per the existing treatment plan; (6) determining aggregate risk scores calculated from distinct data sources (by summing the numeric value assigned to individual risks, such that a differential or offset between the first (or external-source-derived) risk value(s) and second or additional risk values (derived from the annotation and/or augmentation process related to patient-based assessment) are apparent in the display or may be calculated; (7) displaying for visual inspection the differential between the first (or external-source-derived) and the second (or patient-based-assessment-derived) risk values or a calculated differential based on the comparison of two risk sources; (8) associating the risk value differential with interventions as determined via a clinician in documenting follow-up via an Action Plan that is prepopulated with the associated information and which can provide precisely quantified information about real status and/or risk to enable more precise response and routing of the requested action.

A further embodiment of the invention can provide for, in addition to the above steps, the further step of (9) providing feedback mechanisms for assessing institutional data integrity and differential risk between institutional sources and real-time data captured from patients via a medication risk assessment system, and/or the further step of (10) providing one or more mechanisms for more precisely associating downstream interventions with primary, secondary and tertiary risk triggers and documenting these associations.

It will be appreciated that the numbering of the above steps may comport with a sequence of steps provided by one preferred embodiment of the invention, but that other preferred embodiments may reorder some of the above steps in a different sequence and/or may provide for conducting some of the steps in parallel.

### BRIEF DESCRIPTION OF THE DRAWINGS

FIG. 1 illustrates a high-level system diagram according to an embodiment of the invention.

FIG. 2 is a system architecture diagram depicting the interfaces, processing engines, and analytics outputs in a according to at least one embodiment of the invention.

FIG. 3 depicts aspects of information processing steps according to at least one embodiment of the invention.

FIG. 4 depicts processing steps, including determining differential risk, according to an embodiment of the invention.

FIG. 5 illustrates, according to an embodiment of the invention, an example of a data capture and/or annotation screen or web page for medications.

FIG. 6 depicts an example of a further data capture and/or annotation screen according to an embodiment of the invention.

FIG. 7 depicts an example of another further data capture and/or annotation screen according to an embodiment of the invention.

FIG. 8 depicts a medication reconciliation view according to an embodiment of the invention.

FIG. 9 depicts a medication reconciliation history view showing differential risks across data sources and time, according to an embodiment of the invention.

FIG. 10 illustrates a population view of patients, according to an embodiment of the invention.

FIG. 11 depicts an Action Plan according to an embodiment of the invention.

FIG. 12 illustrates a computer-based system according to one or more embodiments.

FIG. 13 illustrates a computer network-based system according to one or more embodiments.

### DETAILED DESCRIPTION

U.S. Provisional Patent Application No. 61/813,995, filed 19 Apr. 2013 by Biernacki et al., is hereby incorporated herein in its entirety.

The invention can be understood further by illustration of multiple embodiments, including one or more preferred embodiments, as related in the more detailed description below; however, it is understood that the full scope of the invention is not limited to these embodiments alone.

In assessing medication risk for high risk patients, many organizations like payers and provider groups that bear their own risk have based risk review or modeling on analyses of well-established records, such as claims data or electronic health records, but this information is likely to be incomplete. There may be significant offsets in retail pharmacy fill data that do not reconcile completely with existing information the payer may have from its Pharmacy Benefit Management (PBM) or internal claims databases that can inform risk or fraud assessment. Important context is missing from claim data, such as clinical indication or specifics regarding usage of the drug. Even clinical sources have gaps, with dispensed information not typically available. Embodiments of the present invention provide for a system that fills this gap by collecting comprehensive data and/or information from a variety of sources and aggregating and presenting this data and/or information for data integrity review, annotation and risk review processes. These external sources can include, for example, without limitation, direct integration of data from Electronic Health Records (EHRs), direct integration to (and/or with) Health Information Exchanges (HIEs), direct claims feeds from the payer/PBM, feeds from data clearinghouses (such as, for example, Surescripts® data clearinghouse; Arlington, Va.), and the patient—via self-reporting, caregiver-assisted reporting, or clinician-mediated engagement with the patient remotely or in person.

Preferred embodiments of the invention provide for any information from a distinct information source being represented as a unique information channel. Due to the fragmented and often incomplete nature of clinical or claims data sources, data can be reviewed or curated by a clinician, and information annotated with additional context. Additional context can include, for example, without limitation: (i) the dosage patterns and usage or adherence patterns a patient is actually following and whether a medication is being taken as directed, (ii) whether a prescribed medication has been issued on discharge from an acute care or inpatient encounter, and (iii) whether a medication is used on an episodic or as-needed basis or on an ongoing or chronic basis. In addition, where certain information channels, such as pharmacy fills or claims may not preserve an explicit association of the dispensed medication to the original diagnosis or problem, creation of an explicit association of medication and problem can provide significant precision and value. Any structured data field captured from external sources, or reporting or annotation via data review interfaces according to embodiments of the invention can be evaluated for impact to the overall regimen risk. Thus, data annotations can specifically factor into any risk analysis performed by risk rules in the system. This enables risk assessment to be performed with more context and precision.

Exemplary embodiments of the invention will now be described more fully below, with reference to the accompanying drawings. This invention may, however, be embodied in many different forms and should not be construed as limited to the embodiments set forth herein; rather, these embodiments are provided so that this disclosure will convey the scope of the invention to those skilled in the art.

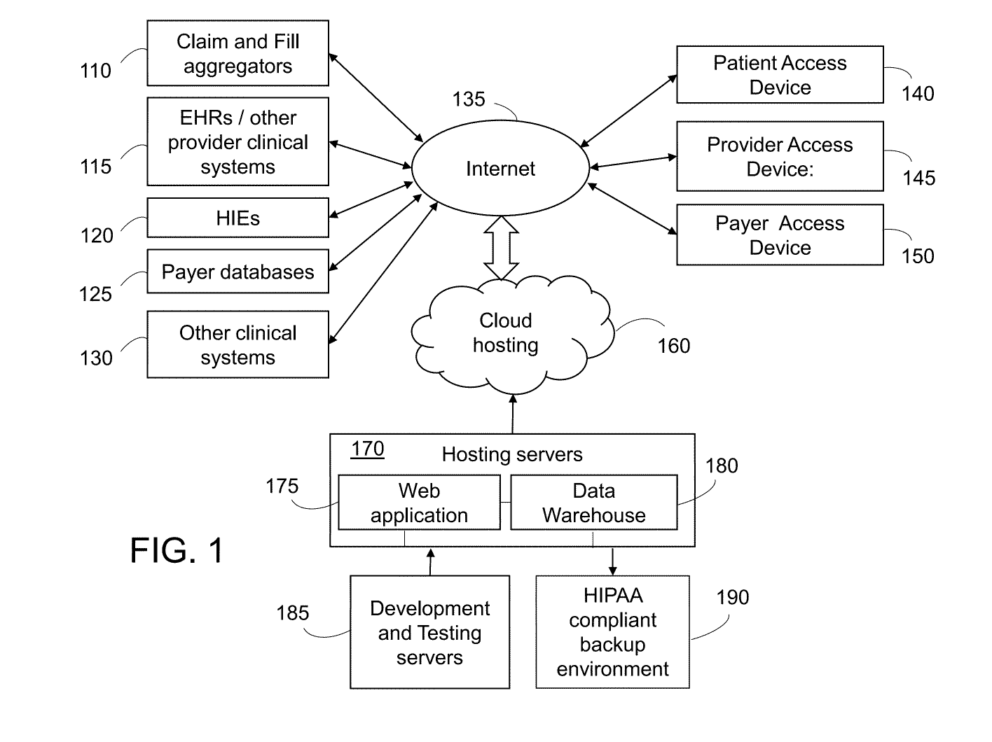

Referring to FIG. 1, a preferred embodiment of the invention provides for a computer-based and network-based system comprising a cloud-hosted solution that is compliant with the Health Insurance Portability and Accountability Act (HIPAA; Pub.L. 104-191, 110 Stat. 1936, enacted Aug. 21, 1996). The system, which can include multiple software modules, can be hosted on secured virtual servers 170, backed by a development and maintenance and/or testing servers 185 and HIPAA-compliant backup modules 190. Users can engage with the system via a variety of interfaces optimized for provider, payer, or patient use and the system can include modules configured for direct data entry, review of data integrated from third party sources, and review of subsequent automated display views and analytics. A preferred embodiment provides also for one or more of patient access devices 140, provider access devices 145 and payer access devices 150. A preferred embodiment provides as well for modules that enable the capture and aggregation of data from a variety of sources, which data sourcing modules can include health plan claims and pharmacy fill data aggregator and clearinghouse data sourcing modules 110, electronic health records (EHRs) or other clinical systems data sourcing modules 115, health information exchanges (HIEs) data sourcing modules 120, payer database sourcing modules 125 and/or other clinical system source data modules 130. One or more preferred embodiments provide for a web application 175 and a data warehouse 180 hosted and interoperable in the server 170 environment. These system components, modules, data sourcing modules, user access devices, and other components, without limitation, are each and in combination interoperable and accessible to each other via the internet 135 and via internet communications protocols. Additionally, various components, modules and functionality of the system can be implemented in a cloud hosting environment 160. Data can be collected and input by the system, or outputs of the system (in the form of medication lists, risk reports, Action Plans) shared back to these data sources for reuse and redistribution.

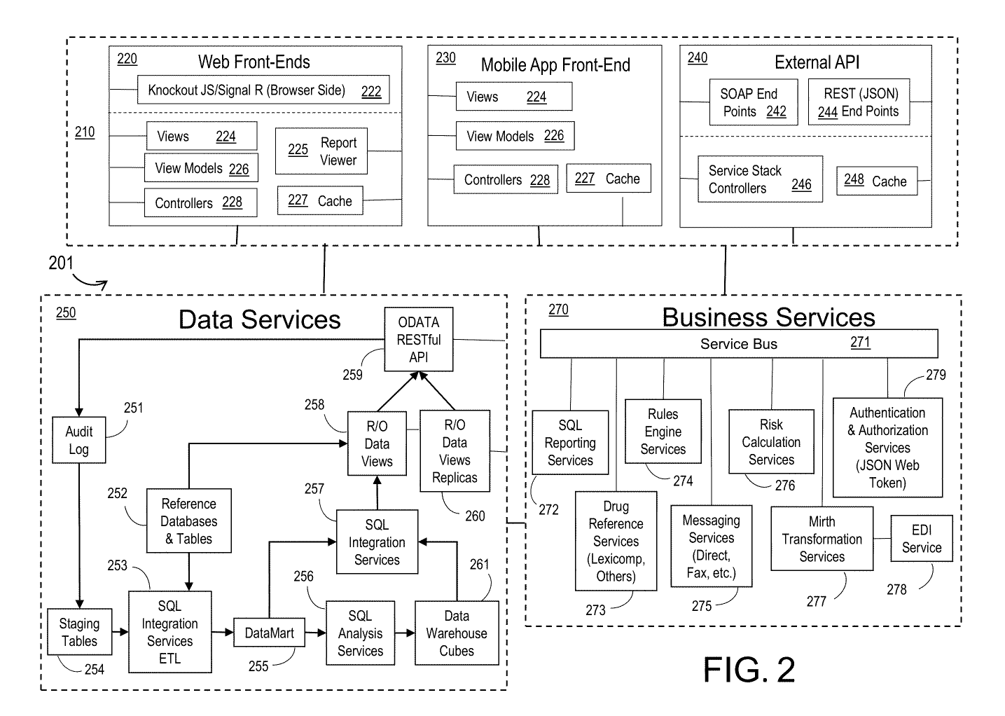

Referring to FIG. 2, a preferred embodiment of the invention can provide for a multilayer system architecture having front end interfaces 220, 230 relating to data capture and review and other related user interaction; data services 250 enabling data understanding and integration, including a data warehouse 261 for storing raw and processed data, and data translation from external sources including but not limited to coordinating communication to outside sources via programming interfaces, including via bar-code scanning with conversion of barcode formats to a parseable National Drug Code (NDC) value, image or voice recognition services, and web services or Electronic Data Interchange (EDI) interfaces; and business services 270 enabling processing engines for information storage and retrieval to and from databases and for processing risk and evaluation rules, and analytics and reporting outputs that relate to medication reconciliation, risk assessment and segmentation, personal medical records and various registries, reports and data mining.

Continuing to refer to FIG. 2, one or more preferred embodiments provide for a system 201 comprising data services modules 250 and business services modules 270, which are interoperably connected with each other and which each are intercommunicably interoperable with additional components and modules of the system comprising, without limitation, external application programming interface (API) 240, web front-ends 220 and mobile application front ends 230. Web front-ends 220 can further comprise Knockout JavaScript (JS) and Signal R components 222 on the browser side (included from Microsoft Corp. development tools to facilitate and accelerate development and delivery of web application functionality) and can further comprise views modules 224, view models 226, controllers 228, report viewer module 225 and cache 227. Similarly, mobile application front-end module 230 can further comprise view module 224, view models 226, controllers 228 and cache 227. The external API components 240 can further comprise Simple Object Access Protocol (SOAP) End points 242, Representational State Transfer (REST) JavaScript Object Notation JSON) End Points 244, Service Stack Controllers 246 and cache 248.

Still referring to FIG. 2, according to at least one preferred embodiment, data services components or modules 250 can further comprise Open Data Protocol (OData) RESTful API 259, Audit Log 251, Staging Tables 254, SQL Integration Services ETL 253, Reference Databases & Tables 252, a DataMart 255, SQL Analysis Services 256, SQL Integration Services 257, Data Warehouse Cubes 261, ReadOnly (R/0) Data Views and R/O Data Views Replicas 260. These components and modules are interoperable with each other and otherwise able to exchange input and output information between each of the various data services components and/or modules.

FIG. 2 provides further illustration of additional details of the business services modules 270 according to at least one preferred embodiment, wherein a service bus 271 can be intercommunicably and interoperably connected with SQL Reporting Services 272, Drug Reference Services 273 (such as, for example, without limitation, Lexicomp brand reference services (Hudson, Ohio) Rule Engine Services 274, Messaging Services 275 (such as, for example, without limitation, direct messaging, Direct Protocol, facsimile transmission and other messaging and communication modes), Risk Calculation Services 276, Mirth interface engine data Transformation Services (open source version of Mirth Connect, Costa Mesa, Calif.) 277, Authentication and authorization services 279 (which can include, for example, without limitation, JSON Web Token) and EDI Service 278, inter alia.

Embodiments of the invention are described herein with reference to block diagrams and flowchart illustrations of systems, methods, apparatuses and computer program products. It will be understood that each block of the block diagrams and flowchart illustrations, and combinations of blocks in the block diagrams and flowchart illustrations, respectively, can be implemented by computer program instructions. These computer program instructions can be loaded onto a general purpose computer, special purpose computer, processor, or other programmable data processing apparatus to produce a machine, such that the instructions which execute on the computer or other programmable data processing apparatus create means for implementing the functions specified in the flowchart block or blocks.

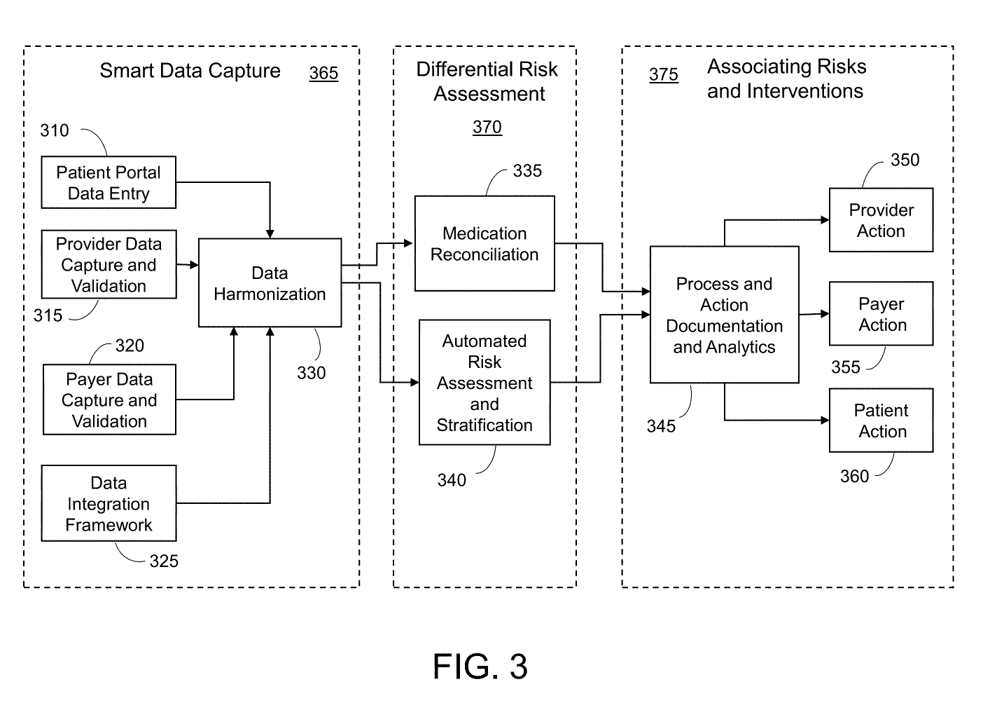

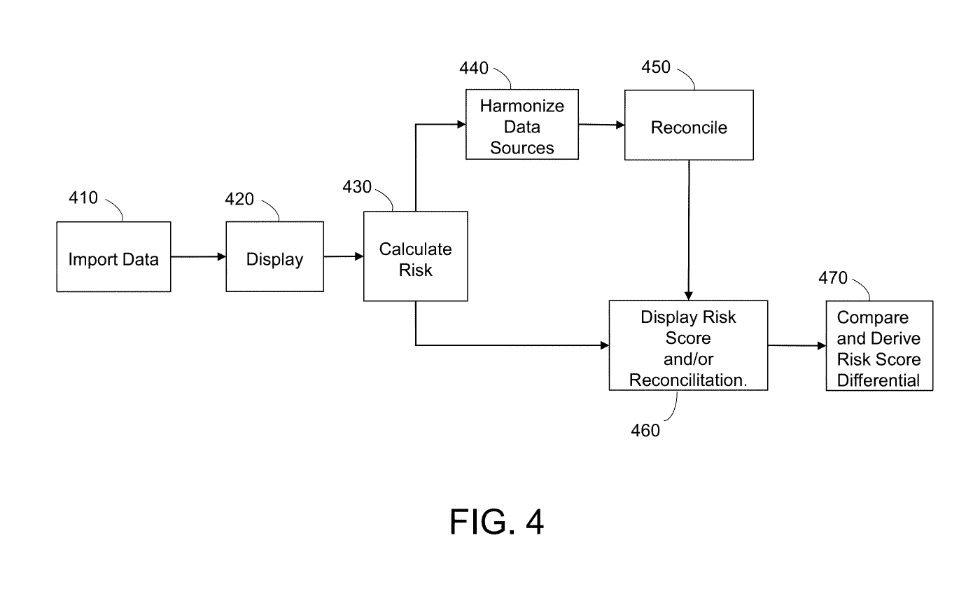

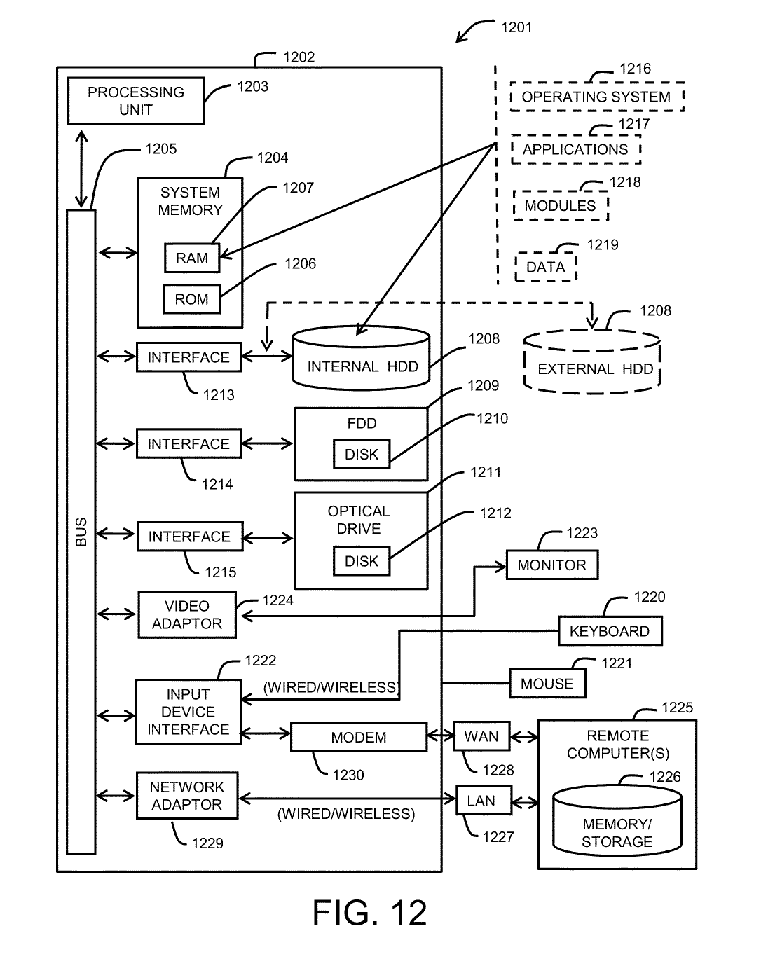

These computer program instructions may also be stored in a computer-readable memory that can direct a computer or other programmable data processing apparatus to function in a particular manner, such that the instructions stored in the computer-readable memory produce an information product and/or information service product according to one or more preferred embodiments, which can further comprise instruction means that implement the functional steps specified in the flowchart block or program process blocks shown in FIG. 3 and FIG. 4, below, and described in the associated text herein referring to these drawings. The computer program instructions may also be loaded onto a computer or other programmable data processing apparatus to cause a series of operational elements or steps to be performed on the computer or other programmable apparatus to produce a computer implemented process such that the instructions that execute on the computer or other programmable apparatus provide elements or steps for implementing the functions specified in the flowchart block or blocks. Further description of a computing system that can be used according to one or more embodiments is found in FIG. 12, below, in the associated text.

Accordingly, blocks of the block diagrams and flowchart illustrations support combinations of means for performing the specified functions, combinations of elements or steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions, elements or steps, or combinations of special purpose hardware and computer instructions.

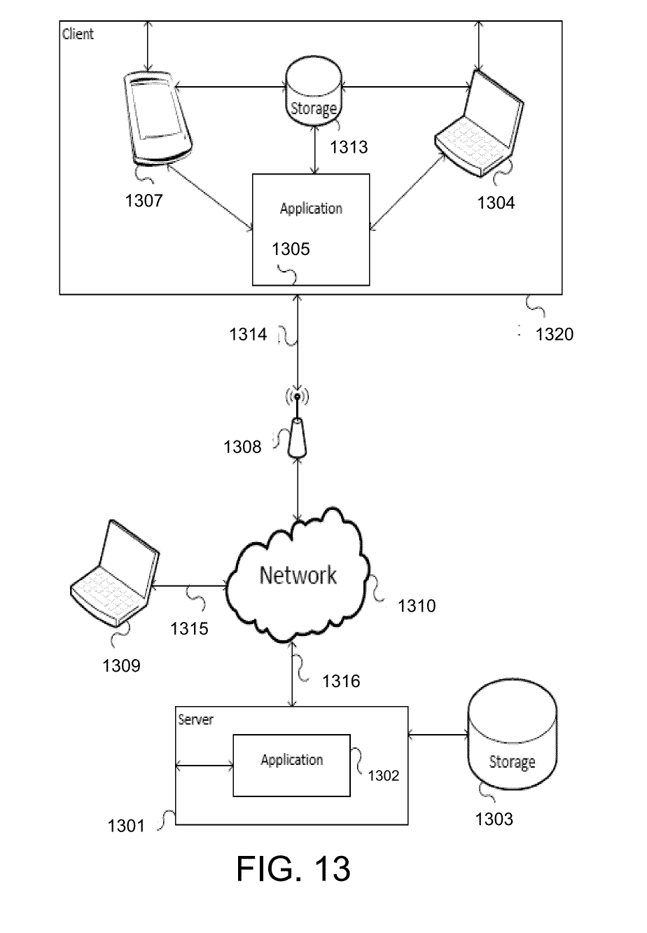

The system can be implemented as software-as-a-service (software hosted centrally hosted on the cloud or set of servers with virtualization capacity and with end user functionality and data services accessed via web browser or mobile-device friendly thin client using HTTPs protocol. Further description of a computer-network system that can be used according to one or more embodiments is found below in association with FIG. 13.

A preferred embodiment of the system can be made available to any type of authorized user of the system, inclusive of clinicians, clinician support resources, or patients and their caregivers according to user authentication model based on organization association (for example, payer or provider group association) and user type and role via a browser interface or mobile-friendly app wrapper to web-based data and user experience delivery. A broad variety of users can be accommodated, with user experiences customized to their role, clinical knowledge or skill level, and workflow—for example the patient interface focuses on data reporting of regimen information and the summary list of medications as an endpoint. A senior clinical user such as a pharmacist, nurse or physician will have full access to data capture, risk analysis and documentation of intervention features, where a para-professional or user with a lower level of clinical licensure may only have access to data capture interfaces. In one embodiment, a web connection is needed to access the system, with information being transmitted over HTTPs, although other embodiments can offer an “offline” or local operating mode for a subset of system activities for data capture and summary in the system when used on a mobile device such as a tablet or smartphone.

Referring now to FIG. 3, at least one preferred embodiment of the invention provides for various user types and flow of activities in multiple embodiments of the system and methods according to the invention. Numbered annotations in FIG. 3 show aspects of the system and methods, including workflow in which previously imported data are annotated, and in which feedback mechanisms (or modules for determining and providing feedbacks) are provided for assessing differential risk and data value between (i) a variety of institutional sources and (ii) real-time data captured from patients via methods and systems according to embodiments of the invention (such as, for example, via methods utilized in the commercial system available from ActualMeds, Inc. (Hartford, Conn.). Another preferred embodiment can provide further for mechanisms (or modules) for associating downstream interventions more precisely to primary, secondary and tertiary factors that are likely causes of risk.

In the context of this disclosure, the term “primary risk trigger” signifies a condition that would indicate a pharmacologic, clinical or situation risk (e.g., presence of a medication in an elderly patient's regimen that would be likely to have strong adverse event implications in an older body or metabolism), the term “secondary risk trigger” signifies a condition that would indicate a pharmacologic, clinical or situation risk when the condition is observed in combination with the primary risk condition (e.g., presence of a medication that has some significant interaction risk with another previously identified medication, or is some modifying factor such as age, usage pattern, etc.) and the term “tertiary risk trigger” signifies a condition that would indicate a pharmacologic, clinical or situation risk when the condition is observed in combination with the primary and secondary risk conditions (e.g., presence of a medication that has some significant interaction risk with another previously identified medication, or is some modifying factor such as age, usage pattern, etc.).

Referring still to FIG. 3, “Smart Data Capture” process 365 (and/or associated program modules) can comprise steps that apply a variety of data-capture tools and workflow mechanisms to deconstruct and/or modularize patient data capture and review processes and activities across a care team. In at least one embodiment, the data capture process 365 can further comprise a step 310 of a patient and/or caregiver directly entering data via data-entry interfaces for patients and caregivers, a step 315 of clinicians providing data capture and validation, and/or a step 320 of payers providing data capture and validation, as well as one or more automated steps 325 that capture data from external sources via a middleware or data integration framework. Patient interfaces and/or caregiver interfaces employed at step 310 can directly support patient engagement and can be leveraged to transform the mechanics of the data capture process into an engaged, integrated “dialogue” with the provider.

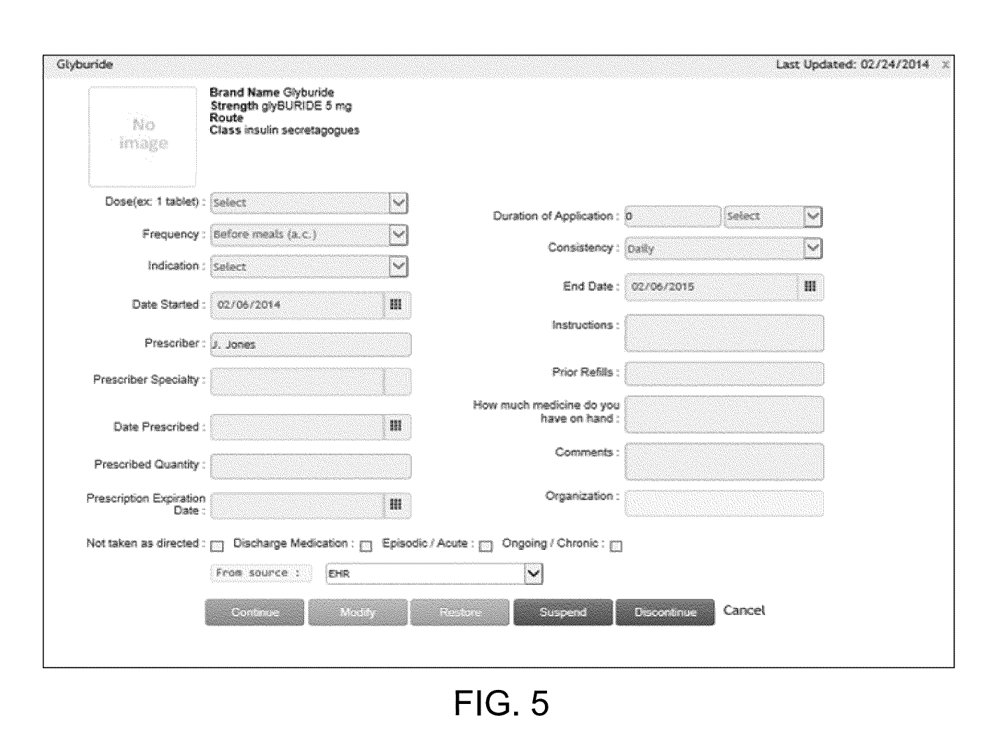

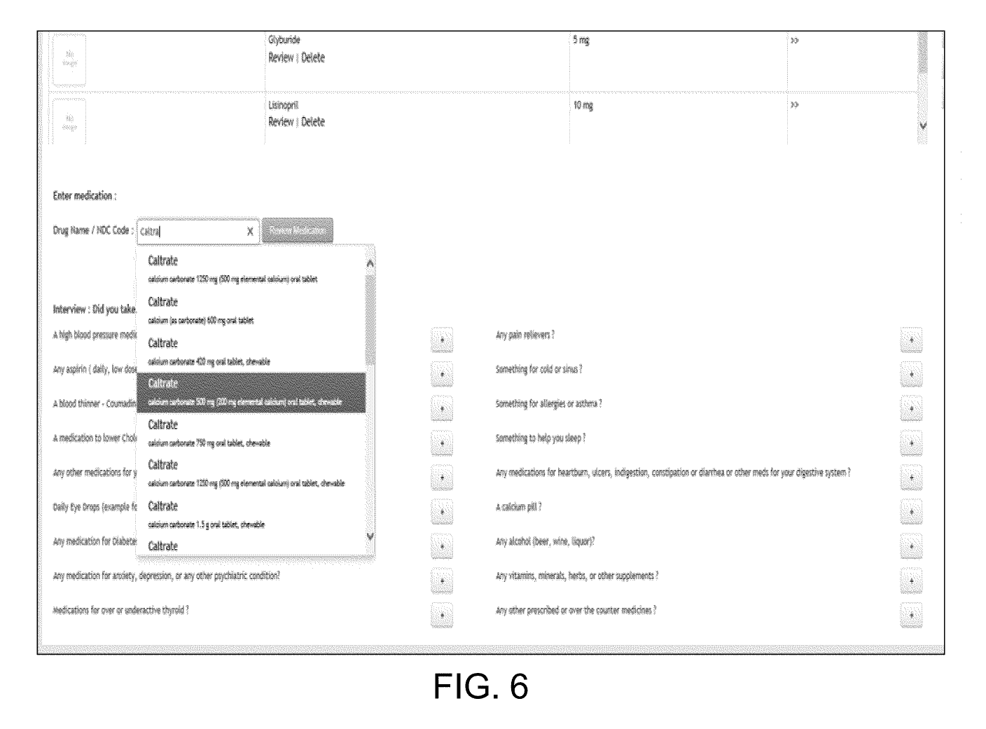

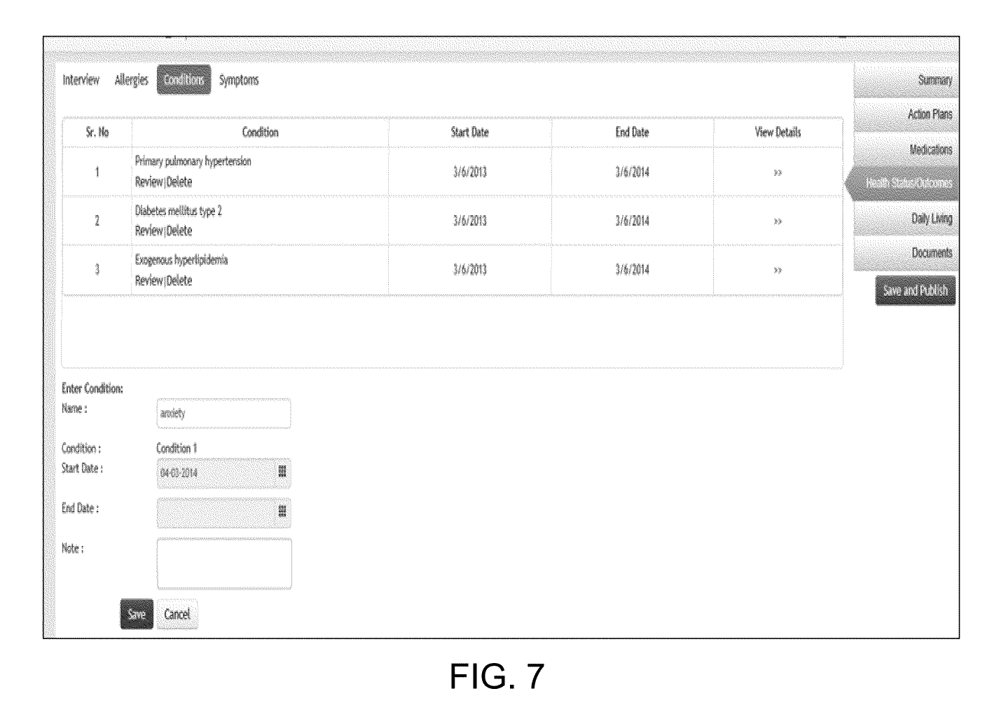

The Clinical Smart Data Capture interface enables the capture, aggregation, review and comparison of data sets, and the ability for any appropriately configured system user to annotate or tag individual data elements that may be additional contributing risk factors. (See FIG. 5, FIG. 6 and FIG. 7, below, for examples of data capture and/or annotation entry web pages according to one or more preferred embodiments, which can provide for data capture interfaces and mechanisms for annotation of specifics of medication or other clinical information such as condition or problem). One or more preferred embodiments of the invention can provide further for improving precision of information used in assessing risk factors associated with medication regimen and/or augmenting or annotating such medication information by gathering, recording, scanning and/or otherwise obtaining data from various levels of hierarchies of drug information, including particular coding schemas (such as, for example, national drug code (NDC) schemas and/or other inventory control codes). For example, such information can come from very explicit, bar code scans and/or very precise inventory control codes. A generic drug, for example, can have a unique national drug code (NDC); however, differences in generics exist based on various drug manufacturing locations, manufacturers and vendors. The coding schema for brand drugs and generics can have different degrees of detail.

Referring still to FIG. 3, a preferred embodiment can provide for a data harmonization step 330 in which “harmonizing” or mapping the coding schema mentioned above, such that two or more data component definitions and identifying characteristics among them merit combination across different coding schemas to the best level of fidelity and precision obtainable, creates a combination that then supports correct reconciliation across multiple sources of data (e.g., same drug by composition, strength and route, but one data source—for example, an e-prescription record sourced from an EHR represents the medication with RxNorm coding schema, and claim information from a different data source represents the equivalent medication with the NDC number corresponding to a particular manufacturer issue of that medication).

According to some embodiments of the invention, scanning the medication bottles of a patient can give bar-code details that can show discrepancy in precision of description between the medication actually being used by the patient and the intended medication per prescription, based on reconciling these harmonized data inputs. Another embodiment of the invention can include image recognition of a pill by size, shape, color, and distinct markings from a snapshot taken from a mobile device or wearable camera, which can facilitate the challenging process of interpreting medication information when original packaging or labeling is not in use or unavailable and/or when the patient or caregiver is not a complete or reliable identifier of the medication in question. Multiple information captures from code or image input introduce a high degree of precision without typing, and thus potentially improve workflow and time on task. This difference in precision can be used according to the invention as a contributing factor in risk (and/or differential risk) associated with a particular patient's medication regimen and is a contributor to observed differential risk to “known” external or institutional sources in more common use. Such medication information specifics captured in these ways that can be annotated (or augmented) include, for example, without limitation, attributes such as (i) primary indication, (ii) dosage patterns, (iii) adherence a patient is actually following, indicating whether or not the patient is taking the medication as directed (iv) whether a prescribed medication has been issued on discharge from an acute care or inpatient encounter, and/or (v) whether a medication is used on an episodic or as-needed basis or on an ongoing or chronic basis.

Referring still to FIG. 3, following data capture processes 365, in a preferred embodiment there is applied a differential risk assessment process 375, within which process a summary and/or comprehensive reconciled data view can be created in a medication reconciliation (or “SmartList”) step 335. Here, various program substeps can additionally comprise integration, synchronization, risk assessment and tailored display of data from multiple parties, processes, and sources to provide a single automated reconciled view of data and risks. The system according to at least one preferred embodiment (such as, for example, the “SmartList provider view”) can provide an “at-a-glance” summary view of medications, other data captured, and risk and risk differential, and can further provide a means of reviewing and mining individual data elements. In an automated risk assessment and stratification step 340, information can be presented in distinct categories by source, with individual and aggregrate risk scores presented for each source, for side-by-side comparison of the differentials in both the data profile and the risk assessment. This information can be presented visually (such as, for example, without limitation, by computerized display on a desktop computer, a laptop, a tablet and/or a smartphone), and differences in risk score can be made available via reports that can show both the differential change in individual and compared risk scores over time.

With continuing reference to FIG. 3, following the steps associated with Differential Risk Assessment processes and/or methods 370, one potential result can be to see higher risk scores for information that has been captured from the patient and annotated, as this information can include medications not available on clinical or claims sources such as over-the-counter (OTCs) and other self medication choices, and this information will also indicate context, such as non-adherence or other risk factors. The more the risk scores of information from institutional sources are in closer alignment with what is captured from real patient behaviors and/or reporting, the higher the likelihood that the patient is under better clinical control. Preferred embodiments of the invention provide for associating risks and interventions via methods 375, which can relate the likelihood that the patient is under better clinical control to a risk assessment associated with the patient's medication regimen. Any individual risk or medication, or a selection of multiple risks or medications can be the trigger for an Action Plan, as depicted in process step 345, which designates some observation or clinical intervention. The summary review or “Smartlist” can also be rendered in a patient or caregiver appropriate form as a Personal Medication Record, with medications summarized from multiple sources, and risk messaging translated into discussion topics or questions for provider dialogue or into customized patient education content. Other various reports or forms, as noted in step 345 (to document processes, recommended actions, and system data), can enable analytics and workflow applications of the system. Either Action Plans or analytics can be routed in step 350 to Providers to drive clinical decisions support or intervention activities, or can be routed in step 355 to Payers for member analytics, or can be routed in step 360 to Patients as part of a patient engagement effort or as part of a cooperative condition or medication management program.

FIG. 4 depicts process steps and mechanisms for differential assessment of data sources and risks provided for by at least one embodiment of the invention. Referring to FIG. 4, a preferred embodiment of the invention can provide for multiple opportunities to create associations between risk factors and subsequent risk scoring in a medication-based risk assessment system.

A preferred embodiment of the invention provides for risks that are assessed and scored based on data from institutional health-care sources to be compared to the risks assessed and scored based on capture of patient data as captured or annotated through an interface according to the invention (such as, for example, the ActualMeds provider gateway. Risks are applied via a rules engine that analyzes at least one and potentially several risk conditions, and based on the presence or absence of these conditions or combinations of these conditions, assigns a risk value to each unique risk circumstance.

Referring again to FIG. 4, to make a risk assessment, one or more lists of medications may be imported from an external source for a given patient in a data import step 410. Each imported list, and any final list created by annotation or validation of data from external sources is also displayed in a display step 420 in a distinct column or “channel” of medications in the user interface, appropriately labeled to make a clear association with the source or process by which it has been derived. For each of the sources, risk is independently assessed and a score calculated by the rules engine in a risk calculation step 430.

In one or more preferred embodiments, at step 430 risks can be determined based on the comparison of a given medication or combination of medications as stored in the medication database tables, and condition of risk defined in a series of tables that define risk condition to be applied. Risk conditions of similar types can be grouped into distinct sets, and specific embodiments of these can be as follows:
1. Medication interaction risk assessment: An application according to one embodiment can have a “medication” database table, which stores medications prescribed to the patient. The Lexicomp database, for example, has a “drug pair's interaction” table that stores the medications' interaction details. The “Interaction details” table contains all details about the risks that are a potential match. To make a determination of risk, the system sequentially applies each medication pair that may occur against the interaction table to determine if an interaction exists for any combination of two medications in “drug pair's interaction” table. If a matching condition exists, this match is stored in the database and the risk details, including a numeric score ranging from 1 to 5 and other attributes that may include, but not be limited to, severity, onset, etc, are logged and interaction risk details for that interaction from “interaction details” table are displayed on the user interface
2. Defined criteria risk assessment: These risks are based on the different risk conditions (as distinct from but not excluding specific medical conditions, problems or diagnoses) that are defined in a “risk conditions” table. If a particular condition or set of conditions is present in the stored patient data, i.e., a condition is satisfied, then the risk is calculated, again based on a 1 to 5 score that is uniquely set for each risk condition combination, and that score displayed on the user interface (which can comprise a risk score display step 460, as shown in FIG. 4). Conditions that determine the risk can include, but are not limited to, conditions such as the following:
   a. Answers given by a patient for a particular set of structured interview questions;
   b. Particular combination of drug classes present in a given medication list that has either been imported or manually derived;
   c. Particular medications or drug class at particular frequencies as noted in the validation process, or with other particular attributes for a medication that may accompany the medication, for example order or fill date;
   d. Comparison to a specific list of items that explicitly define risk. A specific embodiment of this is comparison to a list of medications deemed inherently high risk for patients of a certain age (calculated from birth date as stored elsewhere in the patient record) and presence or absence of the drug on the given list. Specific embodiments of this assessment include assessment of whether a medication is on the American Geriatric Society 2012 revised Beers medication risk assessment, or CMS guidance in accordance with published quality measures; and
   e. Calculations based on the presence or absence of certain medications over a defined reference period of time. One embodiment of this is the calculation of Percentage of Days Covered based on the presence of specific medication for a certain minimum number of days in a reference period as defined in CMS quality measures for adherence.

If the any of the above conditions are satisfied then the risks are calculated—based on the explicitly defined scoring value associated with each unique risk—the positive combination of conditions that matches any one risk criteria is identified and stored, with its associated scoring value, and displayed on the user interface. The scoring value is derived from external reference sources (one embodiment is the Lexicomp drug database drug interaction tables) or directly assigned, using a 5-point scale from 1—Low Risk to 5—Highest Risk. Final risk scores for a given source or channel of data are the aggregate of individual scores, summed and optionally weighted or normalized. Scoring for internally derived rules, or normalization or scorings from external sources is typically determined by a 5-member expert panel assessing and reviewing all contributing risk rule sets and is always based on evidence-based, authoritative, published sources. When a rule set is directly translated from an established evidence based guideline, such as an association practice guideline or federal quality measure, rules review is conducted for accuracy of implementation. The importance weight for each risk condition can be based on the mean of the expert panel ratings.

In at least one preferred embodiment, the rules criteria can be derived from a variety of sources, such as, for example, without limitation, the following sources:
The Lexicomp drug data base, which is used to support medication lists in one or more preferred embodiments and from which the native drug interaction rules are used for basic medication-interaction-based risk assessment;
The American Geriatric Society (AGS) 2012 “Beers” guidelines for high risk medications for the elderly, implemented strictly to AGS published practice guidelines;
The CMS Star measures technical specification, current edition, to support risk rules and reporting for STARS measures D14-D18;
Additional risk rules are derived from a variety of external sources, including, but not limited to, the following:
   American Geriatrics Society (guidelines for management of pain)
      Pharmacological management of persistent pain in older persons http://www.americangeriatrics.org/files/documents/2009_Guideline.pdf
      Vitamin D supplementation, 2014
      American Geriatrics Society Consensus Statement on Vitamin D for prevention of falls and their consequences. J Am Geratr Soc 62:147-152, 2014
   Food and Drug Administration (prescribing inserts, OTC labels)
   Pharmacy Quality Association (PQA) quality measures
   US Federal Agency for Healthcare research and Quality (AHRQ) quality measures
   American Diabetes Association Standards of medical care in diabetes—2013.
   Diabetes Care. 2013; 36 (Supl. 1) S11-S56.
   http://care.diabetesjournals.org/content/36/Supplement_{—}1/S11.full.pdf
   American Heart Assoc., Am College of Cardiology, Centers for Disease Control and Prevention (hypertension, heart failure)
      An Effective Approach to High Blood Pressure Control: A Science Advisory, 2013
      2013 ACCF/AHA Guideline for the Management of Heart Failure
   World Health Organization (alcohol guidelines)
   World Health Organization. (2009). Harmful use of alcohol: The problem.
   UK NHS START STOP Guidelines for older adults re potentially inappropriate prescriptions
   Agricultural Research Service USDA Dietary Reference Intakes for vitamin D, calcium, phosphorus, and magnesium.
   Global Initiative for Chronic Obstructive Lung Disease (COPD)
      Global strategy for the diagnosis, management and prevention of COPD, 2013.
   National Heart Lung Blood Institute (asthma)
      Guidelines for the diagnosis and management of asthma (EPR-3) 2007

In addition, one or more embodiments provide for additional rule sets to be derived around complex interactions, patient behaviors, dosage patterns, etc. based on peer-reviewed evidence and following a Delphi committee review process in order to leverage end-user annotation of medication, problem and allergy data collected in the system.

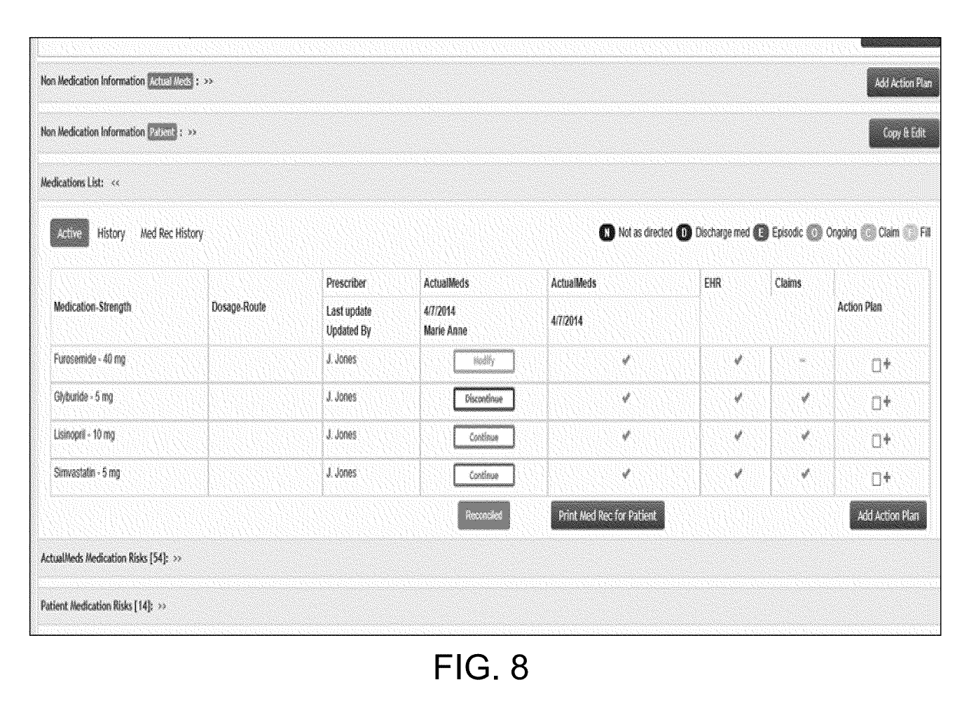

Returning to FIG. 4, separate medication lists derived in the system or imported from external sources are harmonized across different coding schemas in harmonization step 440. Harmonization consists of the process of comparing two or more data component definitions or, in at least one preferred embodiment, coded values and identifying commonalties among them that warrant their being combined, or harmonized, into a single data component. In one or more preferred embodiments, the harmonization of different coding schema values (for example, the Federal Drug Administration NDC or National Drug Code value, and the National Library of Medicine SNOMED or Systematized Nomenclature of Medicine RxNorm value) enables consistent representation, evaluation, comparison and display of medications from dissimilar sources. At reconciliation step 450, the comparison of medications across different source lists is presented visually to enable reconciliation of medications, for which an example of an associated screen display is shown in FIG. 8. The system user can compile a reconciled list from any appropriate data channel item or direct data entry.

Individual risk scores are displayed for each source or channel in risk score and/or reconciliation display step 460, wherein the value displayed is the sum of each contributing risk. This step 460 can include display of a final reconciled list. Specific embodiments can allow for normalization to present an aggregate risk score for a given individual data source. In at least one embodiment, risks can be presented visually in a side by side comparison in step 460. The aggregate risk score for each source can be tracked over time and the offset (differential absolute value) between risks for each channel made visually apparent or explicitly calculated by comparison/subtraction step 470 and tracked over time for trending, convergence or divergence. It is typically expected that the additional review and assessment of data will yield higher risk scores—appropriate risk management and the successful application of precisely tailored interventions are expected to reduce both the differential score between data sources and the absolute risk. This comparison provides insight into real world and real time impact. Risk scores are incremented based on additional findings or annotations in patient medication review, and in turn provide more granularity in exposing and prioritizing risks as captured and displayed. Assessment of differential risk (patient self-reported information versus risk based on data from institutional sources; and/or comparison of different risk assessments between this system and with external data sources) can be applied in at least one preferred embodiment to longitudinal tracking of patients individually and in aggregate, in order to benchmark performance of individuals and populations.

According to one or more preferred embodiments of the invention, (such as, for example, in the medication regimen evaluation system developed by ActualMeds), risk scores can be automatically and dynamically calculated for each distinct data source via the application of a rules engine to a variety of factors. Rules can be applied by assessing the presence of a number of combined factors, and based on the combination of factors, determining an individual risk score of 1 to 5 for each unique combination of factors, where a score 5 can represent the highest risk. Each individual risk score can be summed for the cumulative risk score for each distinct drug list. Rules can be derived from a variety of sources, including, for example, without limitation, from a licensed commercial drug database that can include a comprehensive commodity list of common drug-drug interactions. Risk rule sets may be derived from a variety of possible sources, including under third party license, extracted from peer-reviewed medical literature or evidence sources, or devised from medical best practice. For example, lists of medications commonly in use by the elderly that constitute high risk—for adverse events, severe side effects or drug interaction—have been peer reviewed and published by authoritative sources, including Centers for Medicare & Medicaid Services (CMS; Baltimore, Md.) and/or the American Geriatric Society, inter alia. According to at least one preferred embodiment, encoding of these lists and associated published guidance as a risk rule can flag a combination of factors—such as, for example, without limitation, relevant patient age bracket, medication or medication class, condition or other information captured by the system interfaces—to assign a risk score to the circumstances that match this assessment. Another example, in a further preferred embodiment, is the adverse interaction of given drug A with given drug B, or the presence or absence of a specific response to structured interview questions—each of these examples can receive an individual score based on conditions being met.

Additionally, one or more embodiments of the invention provide for rules that assess a variety of factors that are either (a) not available in the institutional data sources and are obtained via the data annotation process, or (b) obtained by combining risk factors that include medications and other data (such as, for example, without limitation, data or information related to symptoms, conditions, or biometric data). Risk scores from the various rules sources can be normalized and combined for contribution to a final total risk score for each medication list source available for the patient. These scores can be visually depicted adjacent to each other in a medication reconciliation view, as shown in FIG. 8, for example. All risk scoring can be performed “on the fly” as external data is imported or as a medication review is performed via the information capture interfaces in the system. With each medication or key data point added, risks can be calculated and updated in real time.

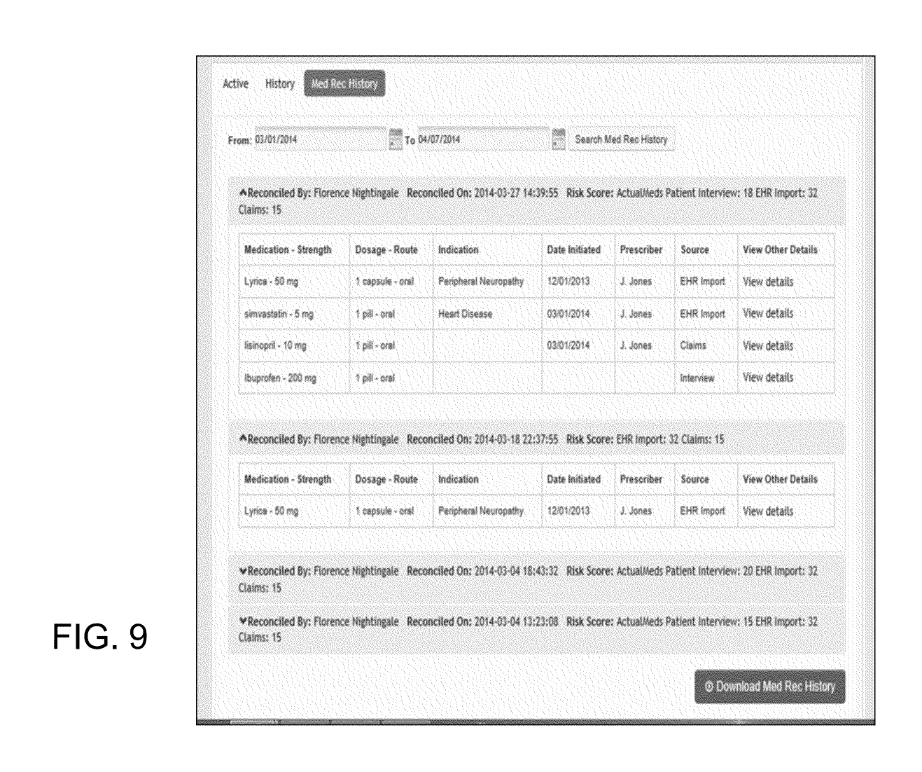

Still referring to FIG. 4 and referring also to FIG. 9, an embodiment can provide for a system in which risk scores can be compared across multiple data feeds either via direct display in the user interface or as an exported data stream with a risk score associated with each data list. One or more preferred embodiments provide for a risk score comparison step 470, in which risk scores are numerically compared by subtraction to derive differential risk scores. Risk scores will typically be higher for medication information gleaned directly from the patient and including self medication patterns with over-the-counter medications (OTCs), supplements, out-of-network medications, and mitigating behaviors or characteristics (such as poor adherence, problematic systems that may be medication adverse effects, or health indicators such as biometric or lab readings for blood pressure, weight, etc.) than from the claims data alone. At least one embodiment employs visual heuristics to indicate risk shifts between data sources.

Review of the differential risk scores and significant contributing factors in the interface can assist payer and/or healthcare-provider to assess critical issues accounting for the differential risk score and to determine whether or not these are items that deserve special attention and intervention by Payer/Provider Group in management of high risk patients and cost. This information in aggregate supports predictive modeling of risk in populations, as patients are rank ordered according to risk in a population view, as depicted in FIG. 7, for example. According to one preferred embodiment of the invention, differential risk is displayed; each data source is separately scored for risk. Differences in the risk score point to where additional information can provide the most significant potential impact for introducing interventions for shifting patients from higher to lower risk tiers. Where there is high differential risk between two data sources, the offset data guides specific intervention opportunities. An additional differential risk may be derived from the comparison of two risks for the same source captured over time. A targeted follow-on action plan can be initiated from any data source (including a specific medication, or other clinical or contextual data), or a specific risk may be determined as the initiation point for the action plan. Each key data or risk section in the user interface can enable the initiation of action plan documentation. The Action Plan form as depicted in FIG. 8, for example, prepopulates the form with data or risk information from the user interface that the user has selected, and a clinician notes appropriate followup on the basis of this contextual information.

In a further embodiment of the invention, additional risk differentials can be determined between risks assessed in a risk assessment system according to the invention (such as, for example, an embodiment of the described system) and risk analyses performed internally by payers or managed care companies. In this instance, reports generated by the method and/or system of the invention can compare risk scores for risk assessment from externally sourced data, and risk scores for patient-reported information as captured and risk-scored in the system of the invention (for example, in one embodiment of the system as developed by ActualMed, Inc.) with other risks from other sources, such as Payer/Provider Group risk reviews that may be available for comparison on a normalized basis. These may be used to compare to institutional risk assessment mechanisms.

According to one or more embodiments, additional opportunities to create associations between risk factors and subsequent risk scoring in a medication-based risk assessment system can be described, as follows:

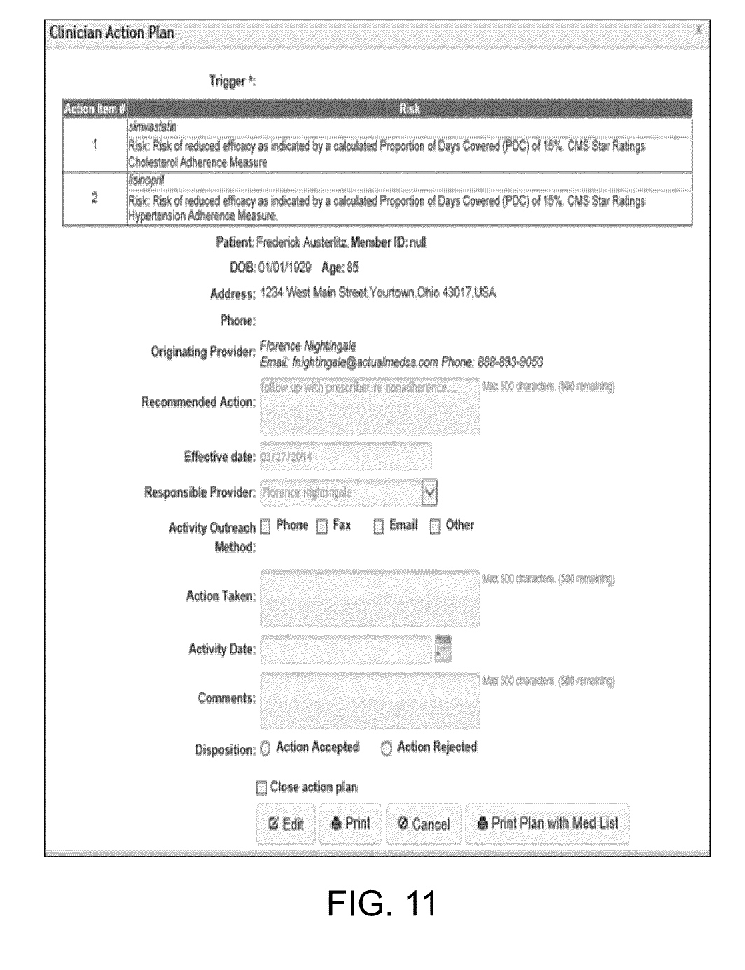

Assess utilization and outcomes from interventions determined as a result of use of ActualMeds system and documented in Medication Action Plans. At least one preferred embodiment of the invention provides for Action Plans, as depicted in FIG. 11, for example, to contain documentation of recommended action associated with either (i) a specific risk-causing medication or combination of medications, or (ii) a specific risk topic, which may include behaviors as well as drugs. Clinician controls in the user interface (UI) can allow the selection of a medication, clinical or situation data, or an identified risk as the basis for documenting a follow-up action. Each distinct Action Plan is initiated based on a selected triggering item, which can include the selection of a specific or several medications, or the selection of a specific or several risk conditions. The selected triggering item or items is included in the Action Plan format by default. Once the initiation of an Action Plan form is selected in the screen by the user, the adjacent trigger item (e.g., medication, risk) for the action is pre-populated in the Action Plan form as shown in FIG. 11.

One or more embodiments of the invention further provide for documenting action(s) and associated responses taken that can be associated with risk scores over time and data-mined for correlations where the strongest association between intervention and risk are observed. Form fields for documenting outreach mechanism, follow-up and disposition of the action plan can be provided, again as shown in FIG. 11. Action plans may be documented for other clinicians, or for the patient or their designated care giver directly. Action Plans content may be routed as message content via any electronic interchange with an external clinical system such as an EHR, as well.

Multiple embodiments of the present invention can be deployed across the care continuum, inclusive of acute or inpatient settings. Certain embodiments, however, can provide focused emphasis on a variety of non-acute or ambulatory settings, which are care settings where medication reconciliation and risk assessment has historically been under-delivered and/or are settings where improved efficiencies and integration of medication reconciliation and risk assessment into care practice. Additional deployments may be focused on specific patient populations or groups, such as patients with multiple conditions and multiple medication regimens, or patients in a specific disease management or care plan. The variety of ambulatory care settings includes outpatient office settings, long term or short term care facilities, community settings, and at-home—all settings where care may be delivered and where capture and review of comprehensive medication information is relevant and timely.

### Example 1

A use case example of how the system, according to at least one preferred embodiment, captures and assesses data is as follows:

Claims data may be accessed and processed via the connection management layer of the system and imported and normalized for assessment alongside of a data stream exported from an electronic health record or health information exchange.

The user interface displays machine-to-machine integrated data sets, provides entry forms and multiple items, such as selection menus for direct entry.

Connectors to each relevant source are programmed into a connection engine to facilitate data exchange—the connection engine maintains the data source or address, connection protocols, data translation, and mapping to data systems internal data representation model. Each available data source is automatically analyzed upon import of the data, and coding schemas and values analyzed first for reconciliation, and secondarily for risk.

Where medication or other data reconciles positively, a visual indication is noted in the system display of medications list or reconciliation status is noted in a data stream.

A patient's real behavior is then assessed—this information may be captured by a clinician or clinician supporting resource at point of care or via patient self-reporting. This information is also automatically assessed for reconciliation to the other data sources and separately risk analyzed.

Comparative risk scores and detail are presented to a system user—who can be the same user who captured the data—or to another system user with a higher level of licensure, who then applies clinical expertise to assessing risks and documenting follow-on interventions in the system that may be routed to other users internally, or routed externally via phone, fax or secure email and resolution and response duly documented.
This use case describes a workflow supporting multiple participants in assessing a shared aggregate data resource and responding according to assigned task.

Referring now to FIGS. 5-7, various embodiments can provide for interactive data capture and/or annotation screens, which can be implemented as web pages displayed on computer screens or on displays of tablets or mobile devices.

Referring to FIG. 9, a preferred embodiment of the invention provides for a medication reconciliation view that can show, for example, without limitation, a comparison of two sets of data: one collected from a claims data source, the other via clinician review. The view can show the data offsets and the differential risk scores of the two different data sets.

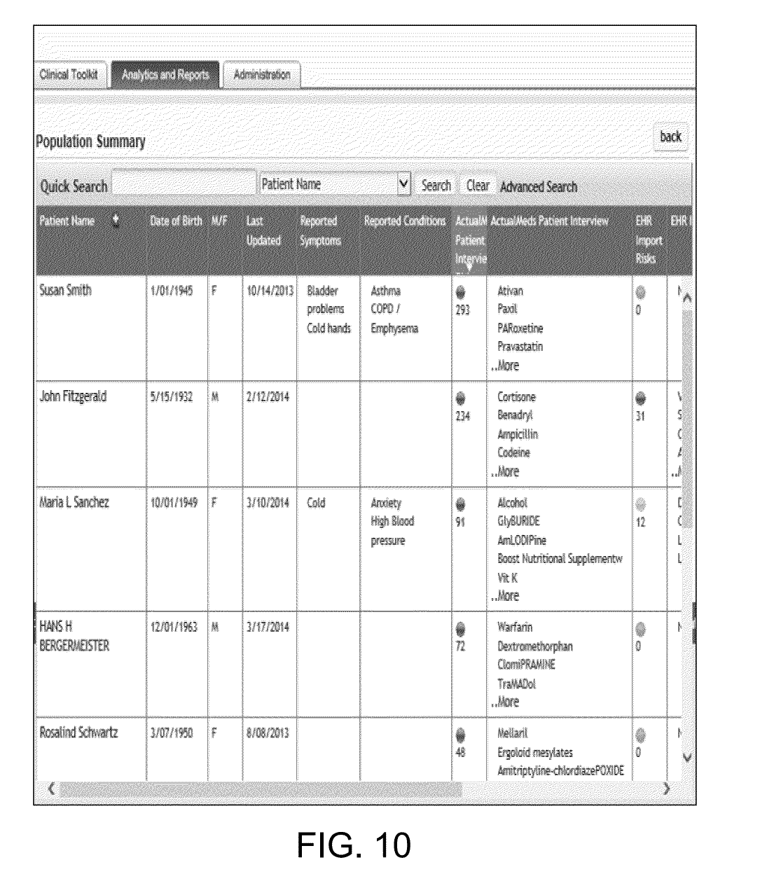

Referring to FIG. 10, at least one preferred embodiment of the invention provides for displaying a population view of patients. This view can indicate automated sorting of patients according to risk scores, and segmentation into different risk tiers as individual visual heuristics noting high, medium or low relative risk ranks.

Referring to FIG. 11, a preferred embodiment can provide for an Action Plan to be used by the clinician in documenting a tailored intervention based on the context or risk score presented in the clinical user interface.

Computing System

Referring now to FIG. 12, there is illustrated a block diagram of a computer operable to execute the disclosed architecture according to one or more preferred embodiments. In order to provide additional context for various aspects of the subject invention, FIG. 12 and the following discussion are intended to provide a brief, general description of a suitable computing environment in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices, including various architectures such as cloud computing.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, cellular, infrared and other wireless media. Combinations of the any of the above should also be included within the scope of computer-readable media.

With reference again to FIG. 12, there is illustrated an exemplary environment 1201 for implementing various aspects of the invention that includes a computer 1202, the computer 1202 including a processing unit 1203, a system memory 1204 and a system bus 1205. The system bus 1205 couples system components including, but not limited to, the system memory 1204 to the processing unit 1203. The processing unit 1203 can be any of various commercially available processors. Dual microprocessors and other multi-processor architectures may also be employed as the processing unit 1203. The system bus 1205 can be any of several types of bus structure that may further interconnect to a memory bus (with or without a memory controller), a peripheral bus, and a local bus using any of a variety of commercially available bus architectures. The system memory 1204 can include read only memory (ROM) 1206 and random access memory (RAM) 1207. A basic input/output system (BIOS) is stored in a non-volatile memory 1206 such as ROM, EPROM, EEPROM, which BIOS contains the basic routines that help to transfer information between elements within the computer 1202, such as during start-up. The RAM 1207 can also include a high-speed RAM such as static RAM for caching data.

Still referring to FIG. 12, the computer 1202 can further includes an internal hard disk drive (HDD) 1208 (e.g., EIDE, SATA), which internal hard disk drive 1208 may also be configured for external use in a suitable chassis (not shown), a magnetic floppy disk drive (FDD) 1209, (e.g., to read from or write to a removable diskette 1210) and an optical disk drive 1211, (e.g., reading a CD-ROM disk 1212 or, to read from or write to other high capacity optical media such as the DVD). The hard disk drive 1208, magnetic disk drive 1209 and optical disk drive 1211 can be connected to the system bus 1205 by a hard disk drive interface 1213, a magnetic disk drive interface 1214 and an optical drive interface 1215, respectively. The interface 1213 for external drive implementations can include at least one or more of Universal Serial Bus (USB) and IEEE 1394 interface, PCIe, Thunderbolt, SCSI, or SAS technologies. The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

Continuing to refer to FIG. 12, a number of program modules can be stored in the drives and RAM 1207, including an operating system 1216, one or more application programs 1217, other program modules 1218 and program data 1219. All or portions of the operating system, applications, modules, and/or data can also be cached in the RAM 1207. It is appreciated that the invention can be implemented with various commercially available operating systems or combinations of operating systems. A user can enter commands and information into the computer 1202 through one or more wired/wireless input devices, e.g., a keyboard 1220 and a pointing device, such as a mouse 1221. Other input devices (not shown) may include a microphone, an IR remote control, a stylus pen, touch screen, bar code scanner, digital camera, Google Glass, or the like. These and other input devices are often connected to the processing unit 1203 through an input device interface 1222 that is coupled to the system bus 1205, but can be connected by other interfaces, such as a parallel port, an IEEE 1394 serial port, a USB port, an IR interface, etc.

FIG. 12 further illustrates a monitor 1223 or other type of display device can be connected to the system bus 1205 via an interface, such as a video adapter 1224. In addition to the monitor 1223, a computer typically includes other peripheral output devices (not shown), such as speakers, printers, etc., without limitation. The computer 1202 may operate in a networked environment using logical connections via wired and/or wireless communications to one or more remote computers, such as a remote computer(s) 1225. The remote computer(s) 1225 can be a workstation, a server computer, a router, a personal computer, portable computer, microprocessor-based entertainment appliance, a peer device, a mobile device (tablet, PDA or smartphone, without limitation) or other common network node, and typically includes many or all of the elements described relative to the computer 1202, although, for purposes of brevity, only a memory storage device 1226 is illustrated. The logical connections depicted include wired/wireless connectivity to a local area network (LAN) 1227 and/or larger networks, e.g., a wide area network (WAN) 1228. Such LAN and WAN networking environments are commonplace in offices, and companies, and facilitate enterprise-wide computer networks, such as intranets, all of which may connect to a global communication network, e.g., the Internet. For the purposes of the present invention, any and all handheld wireless devices such as Apple Inc.'s iPhone (R) brand wireless computing device, Apple Inc.'s iPad (R) brand wireless computing device, any wireless computing devices running Google Inc.'s Android (R) brand operating system, or Microsoft Corp.'s operating system and/or any similar wireless computing devices made by BlackBerry Inc., Nokia, Inc, Samsung Inc. and/or other manufacturers are also considered computers. When used in a LAN networking environment, the computer 1202 can be connected to the local network 1227 through a wired and/or wireless communication network interface or adapter 1229. The adaptor 1229 may facilitate wired or wireless communication to the LAN 1227, which may also include a wireless access point disposed thereon for communicating with the wireless adaptor 1229.

The computer 1202 depicted in FIG. 12 can be operable to communicate with any wireless devices or entities operatively disposed in wireless communication, e.g., a printer, scanner, desktop and/or portable computer, portable data assistant, communications satellite, any piece of equipment or data capture peripheral or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices. When used in a WAN networking environment, the computer 1202 can include a modem 1230, or is connected to a communications server on the WAN 1228, or has other means for establishing communications over the WAN 1228, such as by way of the Internet. The modem 1230, which can be internal or external and a wired or wireless device, is connected to the system bus 1205 via the serial port interface 1222. In a networked environment, program modules depicted relative to the computer 1202, or portions thereof, can be stored in the remote memory/storage device 1226. It will be appreciated that the network connections shown are exemplary and other means of establishing a communications link between the computers can be used.

Referring now to FIG. 13, a networked system according to one or more embodiments can comprise a system server 1301 having application 1302 and storage 1303 intercommunicably connected to each other and to a variety of client devices via a plurality of wired and wireless connections. Server 1301 can be running at least one component of a preferred embodiment of the present invention 1302 and server 1301 can comprise further operating, memory and storage features as characterized for a computing system in FIG. 12. Connection to network 1310 (which, for example, without limitation, can comprise the Internet, in full or in part) can be had via any combination of wired or wireless connections 1316. User device 1309 can be connected to network 1310 via any combination of wired or wireless connections 1315, which in turn can connect to the system server 1301 via connection 1316. A network 1310 can further include a wired Internet network 1315 and/or a wireless network 1314 through which transmissions are distributed by wireless transmitters 1308, as well as other forms of computing and transmission networks, all without limitation. A wireless device 1307, according to some embodiments, is preferably a cellular phone, tablet, or other mobile device capable of connecting to a network via any combination of wired, wireless, infrared, auditory or similar means. In other embodiments a personal digital assistant (PDA) computing device, a personal computer, a laptop computer 1304 or any other device capable of communicating with the server 1301 can be used. An application 1305 stored on the device 1307 and/or device 1304, which application can comprise a web browser application and/or a proprietary application, or a combination of such applications working integrated fashion, can comprise one or more configurations of machine instructions for controlling a computer processor. In some embodiments, software to identify the physical location of the device 1307 or device 1304 can be stored on the devices, and location data as well as other data can be stored in storage media 1313 resident on such devices, or stored in distributed storage locations on the network. Furthermore, the devices 1309, 1307 and 1304 can receive data that are used to enable the user to respond to questions, and to capture the user's answers. Additional applications are able to be included on the server 1301 and on the devices 1309, 1307 and/or 1304, as necessary, for smooth operation of the process and method, according to one or more embodiments. Although some of the applications are described separately above, in some embodiments the applications are included in one large application, or are accessed via any combination of applications on the device.

Still referring to FIG. 13, wireless transceiver 1308 can be WiFi, WiMax, cellular, or other wireless medium, connected to network 1310 via any combination of wired or wireless connections. User devices 1307 and 1304 can be connected to network 1310 via any combination of wired or wireless connections 1314 and to wireless transceiver 1308 running either a standard web browser or a customized application by which they access application 1302 on server 1301 via any combination of wired or wireless transmissions.

Wi-Fi, or Wireless Fidelity, allows connection to the Internet from essentially any location at a home or residence, at a location in a clinic or hospital (including, without limitation, at a bedside, at an intake interview desk, and/or in an examination room), or in an office or conference room at a place of business, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b/g) data rate, for example, or with experimental results that contain both bands (dual band), so the networks can provide real-world performance similar to the basic 10/100/1000BaseT wired Ethernet networks used in many offices.

### Advantages

It can be appreciated that various embodiments of the invention confer numerous advantages and benefits. Prior to the invention, risk assessment has been typically conducted as a standalone activity by payers or managed care companies, whether it is conducted in-house or in concert with partners performing medication and other risk review, and typically based on fixed pools of data. Embodiments of the invention provide further advantage by being able to deliver, without limitation, significant enhancement of data integrity and context through a mechanism for review and annotation of the data. Further benefit derives from embodiments of the system being able to perform data annotation that supports special analytics applied to population health, coding and reimbursement review, and/or quality measure attestation. Additionally, it can be appreciated that benefits flow from being able to further enable assessing differential risk and associating interventions to triggers, which provides a basis for more precise identification of triggering activities that can be addressed to improve polypharmacy and patient health. Embodiments of the invention can close an information loop that has not typically been closed historically in payer medication assessment—i.e., most recommended action plans have previously been transmitted in a way (phone, fax) that has not made traceability or reporting for impact analysis straightforward. In contrast to the historical practice, the current mechanism depicted in FIG. 11 according to one or more embodiments can allow for documentation of interventions to be tied precisely to data in context or risks calculated in context, and to the disposition of the recommended intervention, in order to make clear the outcomes and accountability for any designated clinical follow up.

While the present invention has been described in conjunction with preferred embodiment, one of ordinary skill, after reading the foregoing specification, will be able to effect various changes, substitutions of equivalents, and other alterations to the components, modules and methods set forth herein. It is therefore intended that the patent protection granted hereon be limited only by the appended claims and equivalents thereof.

### REFERENCES

The following references are hereby incorporated herein by reference in their entirety and made a part of this disclosure and specification:
Alicea-Planas, J., Neafsey, P. J., Anderson, E. (2012). Using an e-health intervention to enhance patient visits for hypertension; The nurse practitioner perspective. Journal of Communication in Healthcare, 5(4), 239-249.
Anderson, E. A., Neafsey, P. J., Peabody, S. (2011). Psychometrics for the computer based health care provider relationships scale. Journal of Nursing Measurement, 19(1), 3-16. PMCID: PMC3285535
Lin, C. A., Neafsey, P. J., & Anderson, E. (2010). APRN usability testing of a tailored computer-mediated health communication program. Computers, Informatics, Nursing. 28(1), 32-41. PMCID: PMC2871320

Lin, C. A., Neafsey, P. J., Strickler, Z. (2009). Usability Testing by Older Adults of a Computer-Mediated Health Communication Program. Journal of Health Communication, 14(2), 102-118. PMCID: PMC2964868
Lin, C., Neafsey, P. J., & Strickler, Z. (2006, October). Usability testing of the Personal Education Program—Next Generation (PEP-NG). Paper presented at Understanding and Promoting Health Literacy, NIH, Bethesda, Md.
Lutkus, G., Newcomb, J. & Neafsey, P. J. Reducing adverse self-medication in older workers with hypertension. Poster presented at the Advancing Toward Health: Evidence-based Nursing Applications (ATHENA) Research Conference, University of Connecticut, Storrs, Conn. Apr. 23, 2009
Neafsey, P. J., M'Ian, C. E., Ge, M., Walsh, S. J., & Lin, C. A. (2010). Reducing adverse self-medication behaviors in older adults with hypertension: Results of an e-health clinical efficacy trial. Special Technology and Ageing Issue, Ageing International Online First, 08 December DOI 10.1007/s12126-010-9085-9 PMCID: PMC3092917;
Neafsey, P. J., Anderson, E., Coleman, C., Lin, C. A., M'Ian, C. E., & Walsh, S. (2009). Reducing adverse self-medication behaviors in older adults with the next generation Personal Education

1. A computer-implemented method for assessing medication risk and improving treatment regimen for a patient having an existing treatment regimen, comprising the steps of:
automatically receiving via a computer network or via HTTPs protocol over the internet one or more distinct sets of data elements indicating a current state of a patient's treatment or therapeutic regimen via one or more external sources of clinical or claims information;
calculating, by a computing device, one or more first risk values for the patient associated with each concurrent distinct source of the automatically received first data elements, each one of the first risk values being based on a subset of the automatically received first data elements, wherein the first risk values indicate a likelihood of the patient developing sub-optimal outcome per the existing treatment regimen;
receiving into the data processing system, by a computing device, one or more second data elements in the form of patient-related information, wherein the second data elements are captured directly from a patient, a clinician or a professional conducting a patient assessment; by a computing device, at least one of annotating and augmenting values for the one or more first data elements from information received via the second data elements;
calculating, by a computing device, one or more second risk values for the patient associated with a combination of (i) the automatically received first data elements as annotated or augmented and (ii) the second data elements, each one of the second risk values being based at least in part on data unique to the step of annotating or augmenting values for the one or more first data elements, wherein the second risk values indicate a likelihood of the patient developing sub-optimal outcome per the existing treatment regimen;
determining, by a computing device, a risk value differential between the first and second risk values;
displaying the risk value differential via a computer or electronic display; and
associating the risk value differential with interventions in an Action Plan that updates the existing treatment regimen to an improved treatment regimen.

2. The method of claim 1, further comprising the step of providing a feedback mechanism, by a computing device, for assessing institutional data integrity and differential risk between institutional sources and real-time data captured from patients via a medication risk assessment system.

3. The method of claim 1, further comprising the steps of
associating, by a computing device, downstream interventions with primary, secondary and tertiary risk triggers, and
documenting these associations by a computing device.

4. The method of claim 1, wherein the step of receiving patient-related information via direct capture from the patient, a clinician or other professional conducting a patient assessment further comprises receiving such information via at least one of
data capture by bar-code scanning in order to extract NDC code from commercial UPC codes or other barcoded data sources,
data capture by image recognition,
data capture by structured interviewing, and
direct information reporting from the patient or a caregiver.

5. The method of claim 1, wherein the step of associating the differential risk with interventions in an Action Plan further comprises
optionally automatically prepopulating the Action Plan with the associated information, providing quantified information about at least one of actual health status and risk, and
specifying more precise treatment responses and routing of requested actions.

6. The method of claim 1, wherein step of determining a risk value differential further comprises the step of determining a risk value differential according to data source or time frame.

7. The method of claim 4, wherein the step of receiving patient-related information via direct capture from the patient, a clinician or other professional conducting a patient assessment further comprises the step of receiving such information via direct information reporting from the patient or a caregiver utilizing one or more of bar code scanning, image recognition, voice entry and form-driven computer interface.

8. The method of claim 1, further comprising the steps of
harmonizing separate medication lists derived in the system or imported from external sources across different coding schemas, and
reconciling medications across different source lists.

9. A computing system or apparatus for assessing medication risk and improving treatment regimen for a patient having an existing treatment regimen, comprising:
a processor, and
a memory coupled to the processor, the memory storing processor-executable instructions that when executed direct the processor to:
automatically receive via a computer network or via HTTPs protocol over the internet one or more distinct sets of data elements indicating a current state of a patient's treatment or therapeutic regimen via one or more external sources of clinical or claims information;
compute one or more first risk values for the patient associated with each concurrent distinct source of the automatically received first data elements, each one of the first risk values being based on a subset of the automatically received first data elements, wherein the first risk values indicate a likelihood of the patient developing sub-optimal outcomes per the existing treatment regimen;
receive into the data processing system one or more second data elements in the form of patient-related information, wherein the second data elements are captured directly from a patient, a clinician or a professional conducting a patient assessment;
at least one of annotate and augment values for the one or more first data elements from information received via the second data elements;
compute one or more second risk values for the patient associated with a combination of (i) the automatically received first data elements as annotated or augmented and (ii) the second data elements, each one of the second risk values being based at least in part on data unique to the annotation or augmentation process, wherein the second risk values indicate a likelihood of the patient developing sub-optimal outcomes per the existing treatment regimen;
determine a risk value differential between the first and second risk values according to data source or time frame; and
display the risk value differential via a computer or electronic display.

10. The system of claim 9, wherein the executable instruction to determine a risk value differential further comprises executable instruction to determine a risk value differential according to data source or time frame.

11. The system of claim 9, wherein the executable instruction further comprise instructions to associate the risk value differential with interventions in an Action Plan that updates the existing treatment regimen to an improved treatment regimen.
